(19) United States
(12) Patent Application Publication
(10) Pub. No.: US 2025/0375845 A1
(43) Pub. Date: Dec. 11, 2025

(54) BEAM MECHANISM

(71) Applicant: Delta Electronics, Inc., Taoyuan City (TW)

(72) Inventors: Chi-Huan SHAO, Taoyuan City (TW); Cheng-Hao HUANG, Taoyuan City (TW)

(21) Appl. No.: 18/928,574

(22) Filed: Oct. 28, 2024

(30) Foreign Application Priority Data
Jun. 6, 2024 (CN) 202410729012.1

(51) Int. Cl. B23Q 1/01

(52) U.S. Cl. CPC B23Q 1/017; B23Q 1/015

(57) ABSTRACT

A beam mechanism includes a beam member, a U-shaped member, a sliding member and a moving module. The beam member is made of a carbon fiber material and has a first side wall and a second side wall. The U-shaped member is disposed on the periphery of the beam member, and the U-shaped member extends to the second side wall of the beam member. The sliding member is located on the first side wall of the beam member and is connected to the U-shaped member. The moving module includes a slide rail and a lead screw. The slide rail is disposed on the first side wall of the beam member, and the lead screw is disposed on the second side wall of the beam member and is connected to the U-shaped member.

### CROSS REFERENCE TO RELATED APPLICATIONS

This application claims the benefit of China Patent Application No. 202410729012.1, filed on Jun. 6, 2024, the entirety of which is incorporated by reference herein.

### BACKGROUND OF THE INVENTION

### Field of the Disclosure

The present disclosure relates to a beam mechanism, and in particular it relates to a lightweight beam mechanism.

### Description of the Related Art

In general industry, a machine equipped with a beam mechanism is quite common, and it is a practical machine.

Generally speaking, a beam mechanism may be arranged on the slide rail of a machine, and the motor of the machine can drive the beam mechanism to move. In addition, the beam mechanism is used to connect an external element, such as a robotic arm. In general, due to the heavier weight of the robotic arm, the beam mechanism is generally made of a material with stronger structural properties, such as metal, to bear the weight of the heavier robotic arm. However, in order to maintain sufficient strength to carry the robotic arm, the overall weight of the beam mechanism is also relatively heavy, making it difficult to install on the machine, or to disassemble from the machine.

Therefore, how to design a beam mechanism with a lightweight overall structure and that maintains sufficient structural strength are topics nowadays that need to be discussed and solved.

### BRIEF SUMMARY OF THE INVENTION

Accordingly, one objective of the present disclosure is to provide a beam mechanism to solve the above problems.

According to some embodiments of the disclosure, a beam mechanism is provided. The beam mechanism includes a beam member, a U-shaped member, a sliding member, and a moving module. The beam member is made of a carbon fiber material and has a first side wall and a second side wall. The U-shaped member is disposed on the periphery of the beam member, and the U-shaped member extends to the second side wall of the beam member. The sliding member is located on the first side wall of the beam member and is connected to the U-shaped member. The moving module includes a slide rail and a lead screw. The slide rail is disposed on the first side wall of the beam member, and the lead screw is disposed on the second side wall of the beam member and is connected to the U-shaped member.

According to some embodiments, the moving module further includes a driving motor and a nut, the driving motor is affixed to the second side wall of the beam member and is located on a first end of the beam member, and the nut is sleeved on the lead screw and is connected to the U-shaped member.

According to some embodiments, the moving module further includes a fixed portion which is fixedly disposed on the second side wall of the beam member and is located on a second end of the beam member, and the beam mechanism further includes a counterweight which is detachably connected to the fixed portion.

According to some embodiments, the sliding member is configured to be connected to an external object, the beam mechanism further includes a counterweight which is detachably disposed on the U-shaped member, and the weight of the counterweight corresponds to the weight of the external object.

According to some embodiments, the beam mechanism further includes a metal assembly which is affixed to the first side wall of the beam member, and the metal assembly is located between the sliding member and the beam member.

According to some embodiments, the beam mechanism further includes a plurality of first locking elements, and the metal assembly has a transverse member which extends along a first axis, wherein the first locking elements are configured to lock the slide rail to the transverse member.

According to some embodiments, the beam mechanism further includes a plurality of second locking elements configured to lock the transverse member to the beam member.

According to some embodiments, the metal assembly further includes a side member, the beam mechanism further includes a supporting base and a plurality of third locking elements, and the third locking elements are configured to lock the supporting base to the side member, so that the supporting base supports the beam member.

According to some embodiments, the beam mechanism further includes a plurality of fourth locking elements configured to lock the supporting base to the side member and the beam member so that the supporting base supports the beam member.

According to some embodiments, the supporting base has a base portion, a supporting portion and a first rib portion, the supporting portion extends along a second axis and is connected to the base portion through the first rib portion, and the beam mechanism further includes a first adjustment element configured to pass through the supporting portion and contact the side member, thereby adjusting the included angle between the supporting portion and the side member.

According to some embodiments, the beam mechanism further includes a first lifting element, a second lifting element and a second adjustment element, and the first lifting element and the second lifting element are disposed between the beam member and the base portion.

According to some embodiments, the second adjustment element is configured to pass through the first rib portion to contact the second lifting element, so that the second lifting element moves relative to the first lifting element to adjust the included angle between the beam member and the base portion.

According to some embodiments, the supporting base further has a second rib portion which is connected between the base portion and the supporting portion, and when viewed along the second axis, the first rib portion and the second rib portion are staggered from each other, wherein the second axis is perpendicular to the first axis.

According to some embodiments, when viewed along a third axis, the first adjustment element is disposed between the third locking elements and the fourth locking elements, and the third axis, the first axis and the second axis are perpendicular to each other.

According to some embodiments, the beam mechanism further includes a plurality of first fixed elements, and the metal assembly has a transverse portion which extends along a first axis, wherein the first fixed elements are configured to fix the slide rail to the transverse portion.

According to some embodiments, the metal assembly further has a side portion which is connected to the transverse portion, and the beam mechanism further includes a supporting base and a plurality of second fixed elements, wherein the second fixed elements are configured to fix the supporting base to the side portion and the beam member, so that the supporting base supports the beam member.

According to some embodiments, the supporting base has a base portion, a supporting portion and a rib portion, and the supporting portion extends along a second axis and is connected to the base portion through the rib portion.

According to some embodiments, the beam mechanism further includes a first adjustment element configured to pass through the supporting portion and contact the side portion to adjust the included angle between the supporting portion and the side portion.

According to some embodiments, the transverse portion and the side portion are integrally formed as one piece, and the transverse portion is formed with a plurality of openwork structures.

According to some embodiments, when viewed along a third axis, the slide rail does not overlap the openwork structures, and the third axis is perpendicular to the first axis and the second axis.

The present disclosure provides a beam mechanism, including a beam member, a U-shaped member, a sliding member, a first supporting base and a second supporting base. The first supporting base and the second supporting base are configured to support the beam member and are fixedly disposed on a mechanical platform. The sliding member is slidably connected to the sliding rails on the beam member, and the sliding member is connected to a nut via the U-shaped member.

The beam mechanism may further include a driving motor and a lead screw. The lead screw is connected to the nut, and the driving motor is configured to drive the lead screw to rotate to drive the nut, the U-shaped member and the sliding member to move. It is worth noting that the sliding member and the driving motor are respectively arranged on the opposite sides of the beam member. Therefore, it can avoid the problem in the conventional design that the motor and the sliding member are arranged on the same side, causing the center of gravity to shift to the same side, thereby affecting the movement accuracy.

In addition, in the present disclosure, the beam member 102 is made of carbon fiber material, the beam member 102 may have a hollow tubular structure, and the beam member 102 is connected to the first supporting base 130 and the second supporting base 140 through a metal assembly 106. Based on such a structural configuration, the beam mechanism 100 can have sufficient overall structural strength and can significantly reduce the weight of the beam member 102 so as to achieve overall lightweighting.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic three-dimensional diagram of a beam mechanism 100 installed on a mechanical platform 50 according to an embodiment of the present disclosure.

FIG. 2 is a three-dimensional schematic diagram of the beam mechanism 100 according to an embodiment of the present disclosure.

FIG. 3 is a three-dimensional schematic diagram of the beam mechanism 100 in another view according to an embodiment of the present disclosure.

FIG. 4 is a front view of a partial structure of the beam mechanism 100 according to an embodiment of the present disclosure.

FIG. 5 is a cross-sectional view of the beam mechanism 100 along the line A-A in FIG. 4 according to an embodiment of the present disclosure.

FIG. 6 is a cross-sectional view of the beam mechanism 100 along the line B-B in FIG. 4 according to an embodiment of the present disclosure.

FIG. 7 is a cross-sectional view of the beam mechanism 100 along the line C-C in FIG. 4 according to an embodiment of the present disclosure.

FIG. 8 is a top view of a partial structure of the beam mechanism 100 according to an embodiment of the present disclosure.

FIG. 9 is a cross-sectional view of the beam mechanism 100 along line D-D in FIG. 8 according to an embodiment of the present disclosure.

FIG. 10 is a schematic diagram of a beam mechanism 100A according to another embodiment of the disclosure.

FIG. 11 is a schematic diagram of the beam mechanism 100A in another view according to another embodiment of the disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

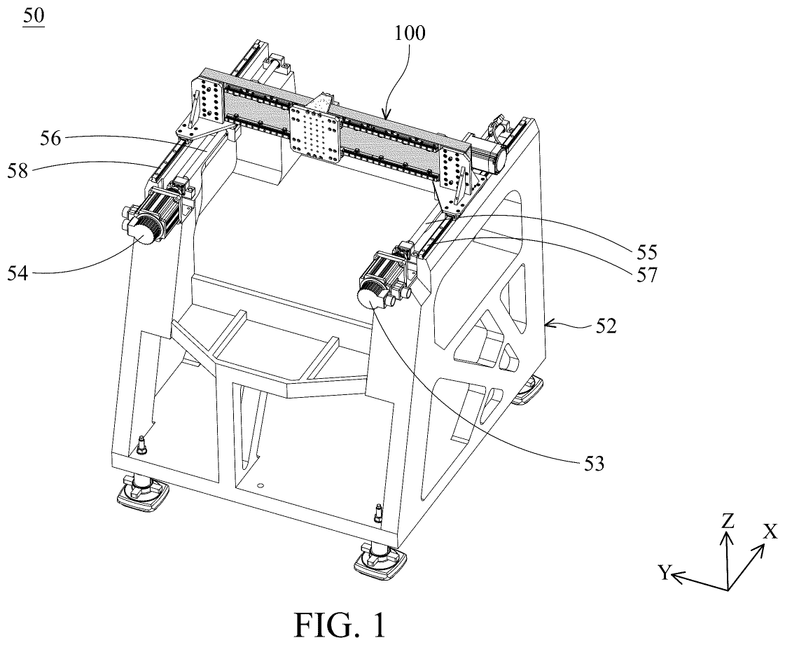

Please refer to FIG. 1. FIG. 1 is a schematic three-dimensional diagram of a beam mechanism 100 installed on a mechanical platform 50 according to an embodiment of the present disclosure. The beam mechanism 100 can be connected to a robot arm (an external object), for example, but it is not limited thereto. For example, it can also be connected to a load block, and so on. In this embodiment, the mechanical platform 50 may include a main body 52, two motors 53 and 54, and two lead screws 55 and 56. The beam mechanism 100 can be connected to the lead screw 55 and 56, and the motors 53 and 54 can drive the lead screw 55 and 56 to rotate, thereby driving the beam mechanism 100 to move forward and backward along the tracks 57 and 58 on the main body 52.

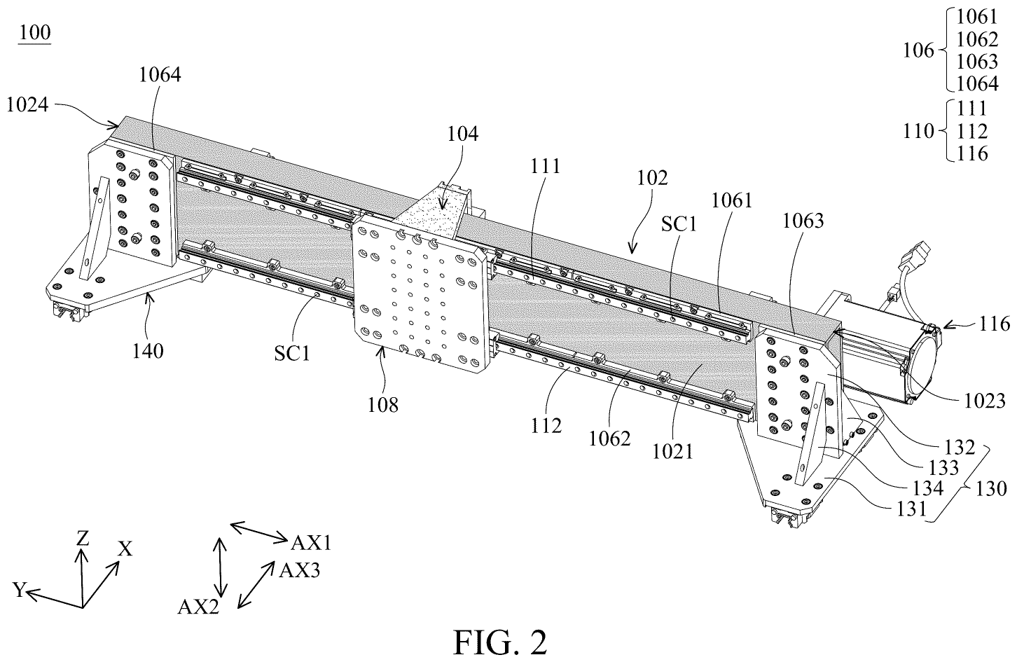

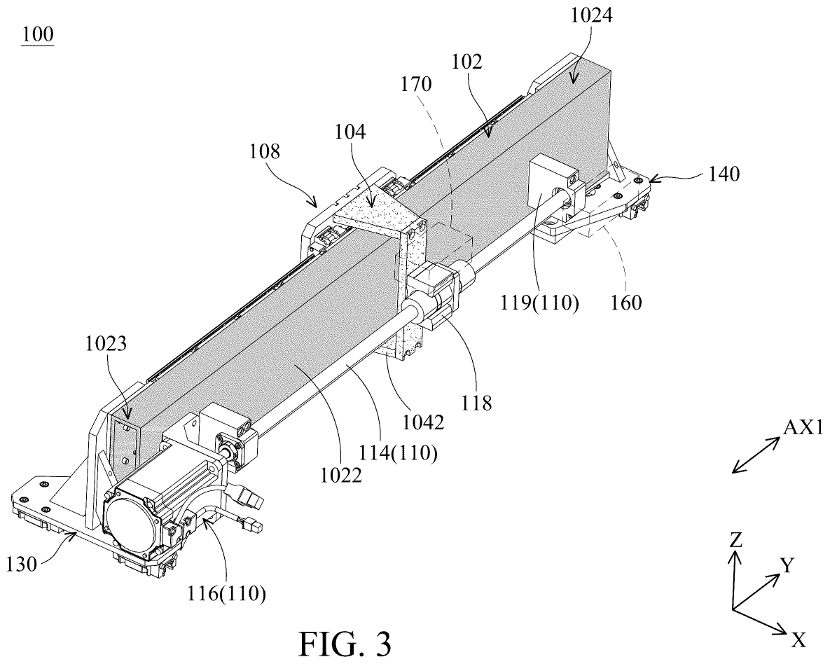

Next, please refer to FIG. 2 and FIG. 3. FIG. 2 is a three-dimensional schematic diagram of the beam mechanism 100 according to an embodiment of the present disclosure, and FIG. 3 is a three-dimensional schematic diagram of the beam mechanism 100 in another view according to an embodiment of the present disclosure. In this embodiment, the beam mechanism 100 may include a beam member 102, a U-shaped member 104, a metal assembly 106, a sliding member 108 and a moving module 110.

The beam member 102 can be formed of a carbon fiber material, but it is not limited thereto. The beam member 102 can have a first side wall 1021 and a second side wall 1022. The U-shaped member 104 is disposed on the periphery of the beam member 102, and the U-shaped member 104 may extend toward a second side wall 1022 of the beam member 102, as shown in FIG. 3.

The metal assembly 106 is affixed to the first side wall 1021 of the beam member 102, and the metal assembly 106 is located between the sliding member 108 and the beam member 102. The metal assembly 106 is, for example, fixedly connected to the first side wall 1021 of the beam member 102 through glue, but it is not limited thereto. In other embodiments, the beam member 102 and the metal assembly 106 may be connected to each other by insert molding technology.

In this embodiment, as shown in FIG. 2, the metal assembly 106 may have a transverse member 1061 and a transverse member 1062. The transverse member 1061 and the transverse member 1062 extend along a first axis AX1 respectively. The first axis AX1 is parallel to the Y axis, for example.

Furthermore, as shown in FIG. 2 and FIG. 3, the moving module 110 may have a slide rail 111, a slide rail 112, a lead screw 114, a driving motor 116, a nut 118 and a fixed portion 119. The slide rails 111 and 112 are disposed on the first side wall 1021 of the beam member 102. Specifically, the slide rails 111 and 112 are respectively fixed on the transverse members 1061 and 1062 and extend along the first axis AX1.

Furthermore, as shown in FIG. 3, the lead screw 114 is disposed on the second side wall 1022 of the beam member 102 and is connected to the U-shaped member 104. Specifically, the nut 118 is sleeved on the lead screw 114 and is fixedly connected to the U-shaped member 104, so that the lead screw 114 is connected to the U-shaped member 104 via the nut 118.

The driving motor 116 is affixed to the second side wall 1022 of the beam member 102 and is located on a first end 1023 of the beam member 102. The fixed portion 119 is fixedly disposed on the second side wall 1022 of the beam member 102 and is located on a second end 1024 of the beam member 102, and the lead screw 114 is connected between the driving motor 116 and the fixed portion 119.

As shown in FIG. 2, the sliding member 108 is located on the first side wall 1021 of the beam member 102 and is fixedly connected to the U-shaped member 104. The sliding member 108 may have a plate-shaped structure, but it is not limited thereto. The sliding member 108 can be configured to connect the external object, such as the robotic arm. Therefore, as shown in FIG. 2 and FIG. 3, when the driving motor 116 drives the lead screw 114 to rotate, the nut 118 can drive the U-shaped member 104 and the sliding member 108 to move along the slide rails 111 and 112.

In addition, it is worth noting that in order to balance the weight of the driving motor 116, the beam mechanism 100 may further include a counterweight 160 which is detachably connected to the fixed portion 119. The weight of counterweight 160 corresponds to the weight of driving motor 116. For example, the weight of the counterweight 160 may be substantially equal to the weight of the driving motor 116, and the error between them may be about 5%, for example.

Furthermore, when the sliding member 108 is connected to the aforementioned external object, the beam mechanism 100 may further include another counterweight 170, which is detachably disposed on the U-shaped member 104, and the weight of the counterweight 170 corresponds to the weight of the external object.

For example, the weight of the counterweight 170 is substantially equal to the weight of the external object, and the error between them is, for example, 5% to 10%. Based on such a configuration, it can be ensured that when the sliding member 108 is connected to the external object, the beam member 102 will not tilt, resulting in a reduction in movement accuracy.

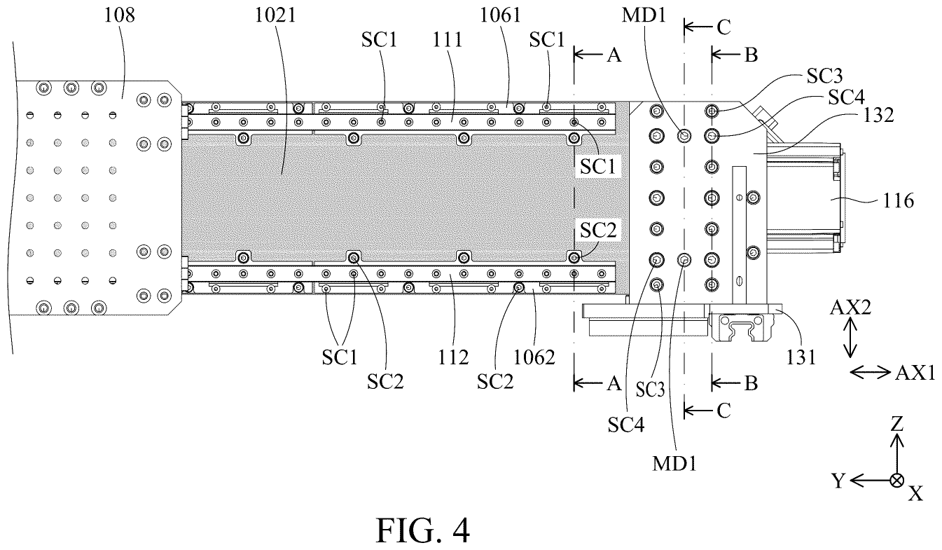

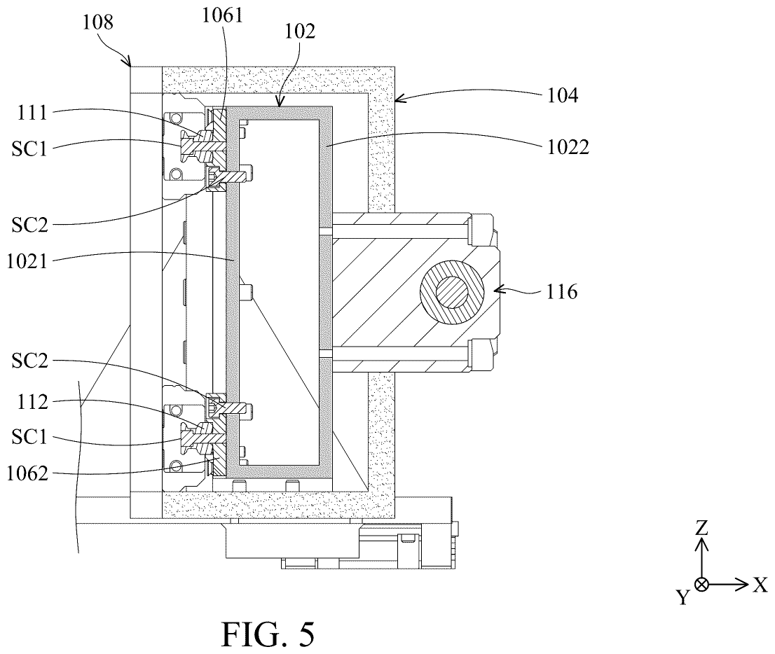

Next, please refer to FIG. 2 to FIG. 5. FIG. 4 is a front view of a partial structure of the beam mechanism 100 according to an embodiment of the present disclosure, and FIG. 5 is a cross-sectional view of the beam mechanism 100 along the line A-A in FIG. 4 according to an embodiment of the present disclosure. In this embodiment, the beam mechanism 100 may further include a plurality of first locking elements SC1 configured to lock the slide rails 111 and 112 to the transverse members 1061 and 1062 respectively.

Furthermore, the beam mechanism 100 further includes a plurality of second locking elements SC2 configured to lock the transverse member 1061 and the transverse member 1062 to the beam member 102. The first locking elements SC1 and the second locking elements SC2 can be screws, but they are not limited thereto.

It is worth noting that, as shown in FIG. 5, these second locking elements SC2 pass through transverse members 1061, 1062 and the first side wall 1021, these first locking elements SC1 only pass through the slide rail 111, 112 and the transverse members 1061 and 1062 but do not pass through the first side wall 1021, and the number of the second locking element SC2 is less than the number of the first locking element SC1.

Based on such a configuration, the number of the opening of the first side wall 1021 can be reduced, thereby increasing the overall structural strength of the beam member 102.

In this embodiment, as shown in FIG. 2, the metal assembly 106 may further have two side members (a first side member 1063 and a second side member 1064), and the first side member 1063 and the second side member 1064 are respectively affixed to the aforementioned first end 1023 and the aforementioned second end 1024 of the beam member 102.

Furthermore, the beam mechanism 100 may further include two supporting bases (a first supporting base 130 and a second supporting base 140), which are respectively disposed on the first end 1023 and the second end 1024 of the beam member 102 and configured to support the beam member 102. Because the first supporting base 130 is symmetrical to the second supporting base 140, only the detailed structure of the first supporting base 130 will be described in the following paragraphs.

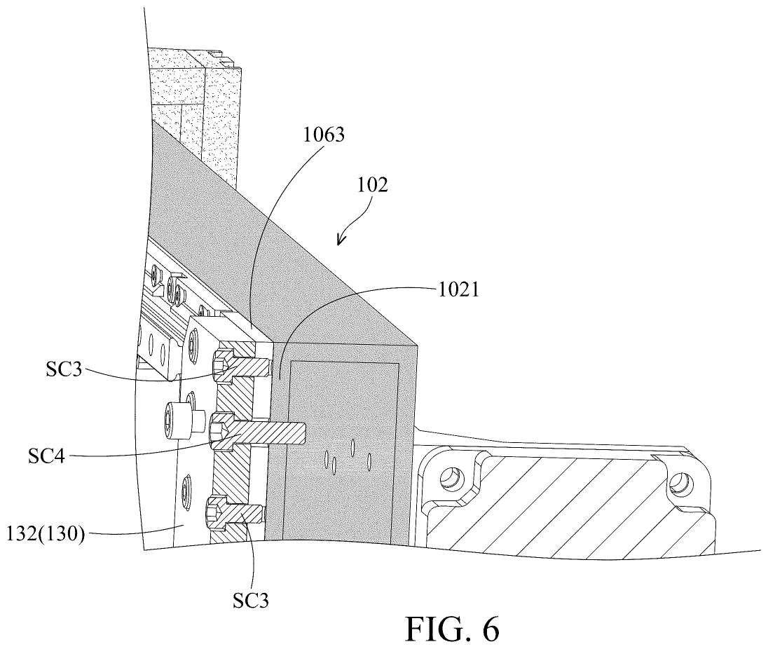

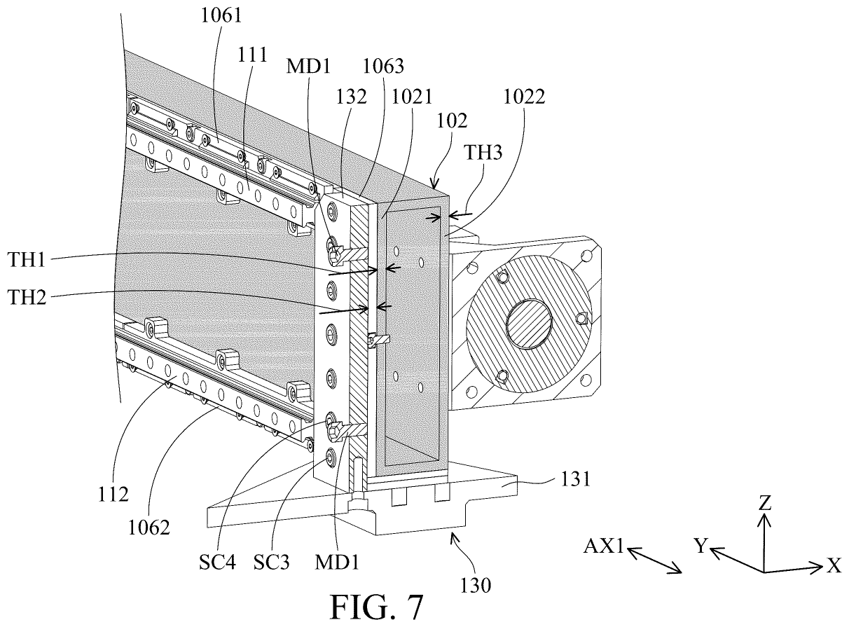

Next, please refer to FIG. 2, FIG. 4, and FIG. 6 to FIG. 7. FIG. 6 is a cross-sectional view of the beam mechanism 100 along the line B-B in FIG. 4 according to an embodiment of the present disclosure, and FIG. 7 is a cross-sectional view of the beam mechanism 100 along the line C-C in FIG. 4 according to an embodiment of the present disclosure. As shown in FIG. 2, the first supporting base 130 has a base portion 131, a supporting portion 132, a first rib portion 133 and a second rib portion 134.

The base portion 131 and the supporting portion 132 may each have a plate-shaped structure, and the supporting portion 132 extends from the base portion 131 along a second axis AX2. The supporting portion 132 is connected to the base portion 131 through the first rib portion 133 and the second rib portion 134. The second axis AX2 is, for example, parallel to the Z-axis and is perpendicular to the first axis AX1.

That is, the first rib portion 133 and the second rib portion 134 are connected between the base portion 131 and the supporting portion 132. The base portion 131, the supporting portion 132, the first rib portion 133 and the second rib portion 134 may be made of metal and integrally formed as one piece, but they are not limited thereto. For example, they can also be connected to each other by welding or screws.

As shown in FIG. 4 and FIG. 6, the beam mechanism 100 may further include a plurality of third locking elements SC3, and these third locking elements SC3 are configured to lock the supporting portion 132 of the first supporting base 130 to the first side member 1063, so that the first supporting base 130 supports the beam member 102.

Furthermore, the beam mechanism 100 may further include a plurality of fourth locking elements SC4, and these fourth locking elements SC4 are configured to lock the supporting portion 132 of the first supporting base 130 to the first side member 1063 and the first side wall 1021 of the beam member 102, so that the first supporting base 130 supports the beam member 102.

Similarly, another portion of the third locking elements SC3 in the beam mechanism 100 is configured to lock the second supporting base 140 to the second side member 1064, and another portion of the fourth locking elements SC4 is configured to lock the second supporting base 140 to the second side member 1064 and the first side wall 1021 of the beam member 102, so that the second supporting base 140 supports the beam member 102.

It is worth noting that, as shown in FIG. 6, the length of the fourth locking element SC4 is greater than the length of the third locking element SC3, and the fourth locking element SC4 passes through the first side wall 1021 but the third locking element SC3 does not pass through the first side wall 1021. The number of the third locking elements SC3 is greater than the number of the fourth locking elements SC4. Based on this configuration, the number of the opening of the first side wall 1021 can be reduced, thereby increasing the overall structural strength of the beam member 102.

In this embodiment, as shown in FIG. 7, when viewed along the first axis AX1, the beam member 102 may have a square tubular structure, and the thickness TH1 of the first side wall 1021 of the beam member 102 is different from the thickness TH2 of the first side member 1063. For example, the thickness THI is, for example, 4 to 5 mm, and the thickness TH2 is, for example, 6 to 10 mm (or 6 to 8 mm), but they are not limited thereto.

In this embodiment, the thickness of the beam member 102 is a uniform thickness, but it is not limited thereto. In other embodiments, the thickness THI of the first side wall 1021 may be less than the thickness TH3 of the second side wall 1022 so as to achieve the purpose of lightweighting.

In addition, as shown in FIG. 4 and FIG. 7, the beam mechanism 100 may further include two first adjustment elements MD1 configured to pass through the supporting portion 132 and contact the first side member 1063, thereby adjusting the included angle between the supporting portion 132 and the first side member 1063.

Due to production tolerances, the contact surfaces of the supporting portion 132 and the first side member 1063 may not be completely flat, so that the supporting portion 132 may not be parallel to the first side wall 1021 and the first side member 1063. That is, the first side wall 1021 and the first side member 1063 may not be perpendicular to the base portion 131 (such as the horizontal plane).

Therefore, when the operator wants to fix the first supporting base 130 to the beam member 102, he/she can first use the first adjustment element MD1 to adjust the aforementioned included angle, and confirm that the first side wall 1021 is perpendicular to the base portion 131. After that, the third locking elements SC3 and the fourth locking elements SC4 are then used to reliably fix the first supporting base 130 to the first side wall 1021.

Based on such a design, there is no need to use the first supporting base 130, the first side member 1063 and the beam member 102 with high accuracy, so that the production cost and manufacturing time can be reduced.

In addition, as shown in FIG. 2 and FIG. 4, when viewed along a third axis AX3 (the X-axis), the third locking elements SC3 and the fourth locking elements SC4 are arranged in two columns. The layout is arranged on the first supporting base 130, and the two first adjustment elements MD1 are disposed between the two columns of the third locking elements SC3 and the fourth locking elements SC4.

The third axis AX3, the first axis AX1 and the second axis AX2 are perpendicular to each other. In addition, the number of the first adjustment elements MD1 is not limited to two, and may be one or more than two.

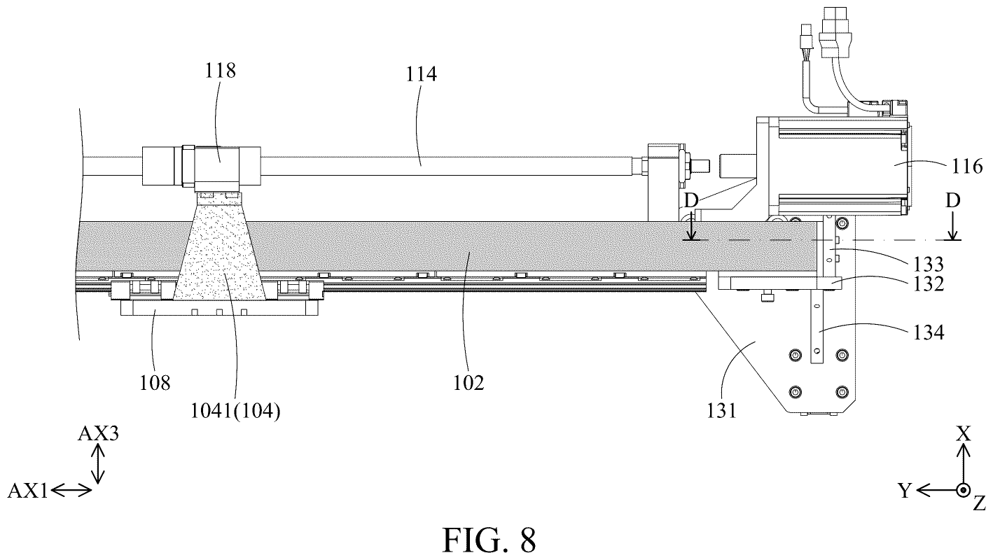

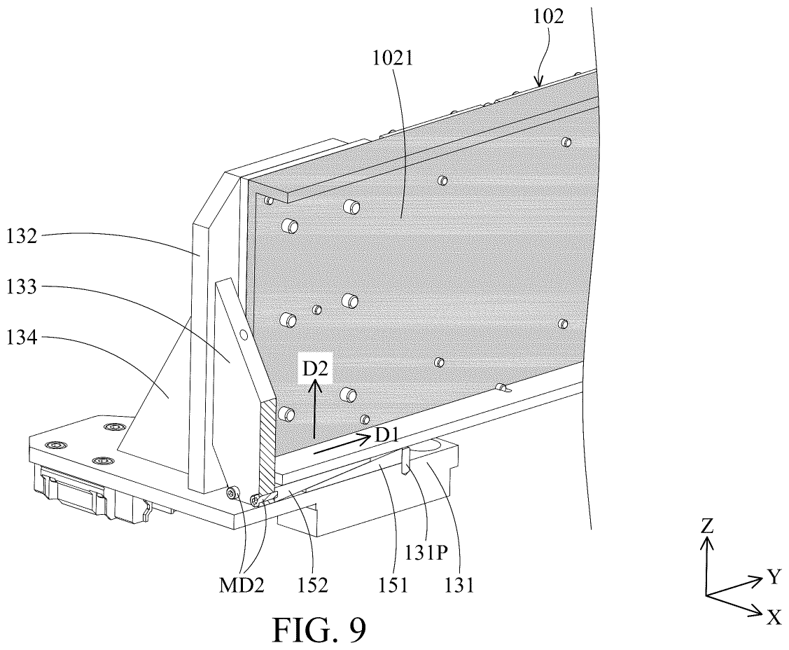

Next, please refer to FIG. 8 to FIG. 9. FIG. 8 is a top view of a partial structure of the beam mechanism 100 according to an embodiment of the present disclosure, and FIG. 9 is a cross-sectional view of the beam mechanism 100 along line D-D in FIG. 8 according to an embodiment of the present disclosure. As shown in FIG. 8, when viewed along the second axis AX2, the first rib portion 133 and the second rib portion 134 are staggered from each other. Based on this configuration, the first supporting base 130 can support the beam member 102 more firmly.

In addition, as shown in FIG. 8, when viewed in a direction perpendicular to the first axis AX1 (for example, when viewed along the second axis AX2), an upper section portion 1041 of the U-shaped member 104 has a trapezoidal structure. Similarly, the lower section portion 1042 (FIG. 3) on the other side of the U-shaped member 104 can also have a trapezoidal structure. Based on such a design, the overall size of the U-shaped member 104 can be reduced while maintaining sufficient connection strength, thereby achieving the purpose of lightweighting.

Next, continue to refer to FIG. 9. In this embodiment, the beam mechanism 100 may further include a first lifting element 151, a second lifting element 152 and two second adjustment elements MD2, and the first lifting element 151 and the second lifting element 152 are disposed between the beam member 102 and the base portion 131.

The second adjustment element MD2 is, for example, a screw, configured to pass through the first rib portion 133 and then contact the second lifting element 152, so that the second lifting element 152 moves relative to the first lifting element 151 to adjust the included angle between the beam member 102 and the base portion 131, and therefore the beam member 102 can be parallel to the horizontal plane (for example, parallel to the base portion 131). Similarly, the number of the second adjustment elements MD2 is not limited to two, and may be one or more than two.

For example, as shown in FIG. 9, when the second adjustment elements MD2 move in a first direction D1, because the second lifting element 152 and the first lifting element 151 each have a triangular plate structure, the second lifting element 152 moves in a second direction D2 to lift the beam member 102, and vice versa. In addition, it should be noted that a blocking portion 131P may be disposed on the base portion 131 to block the first lifting element 151 from moving relative to the base portion 131. The blocking portion 131P may be a protruding block or a screw, but it is not limited thereto.

Based on such a design, there is no need to use the first supporting base 130 and the beam member 102 with higher accuracy to ensure that the beam member 102 maintains to be parallel to the horizontal plane, thus reducing production costs and manufacturing time. In addition, the second supporting base 140 also has the same adjustment elements and configuration, and its operation manner and effect are the same, so they are not described again herein.

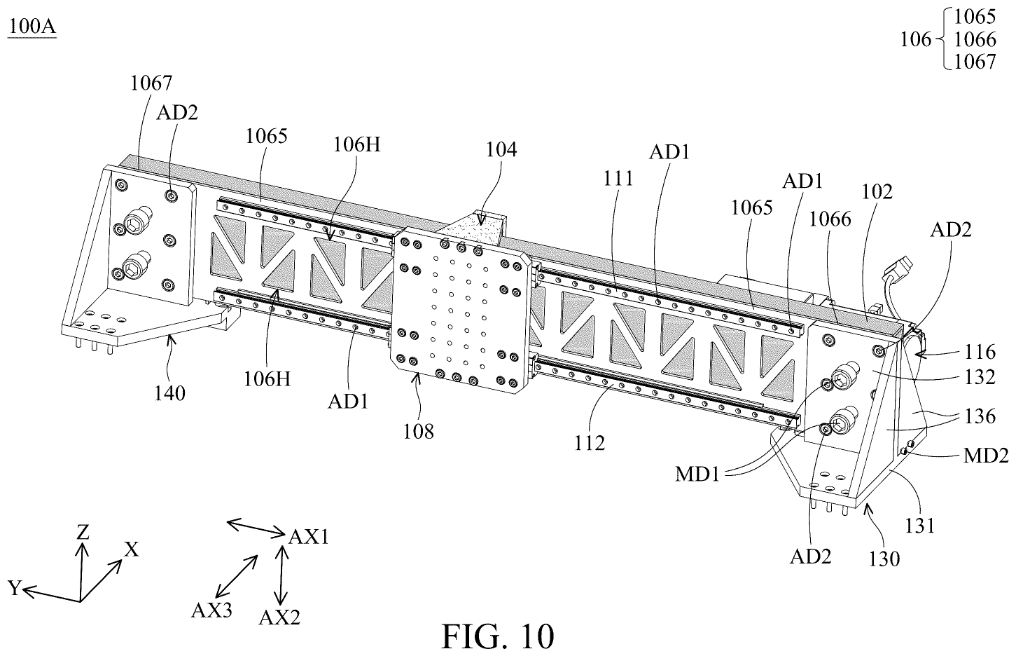

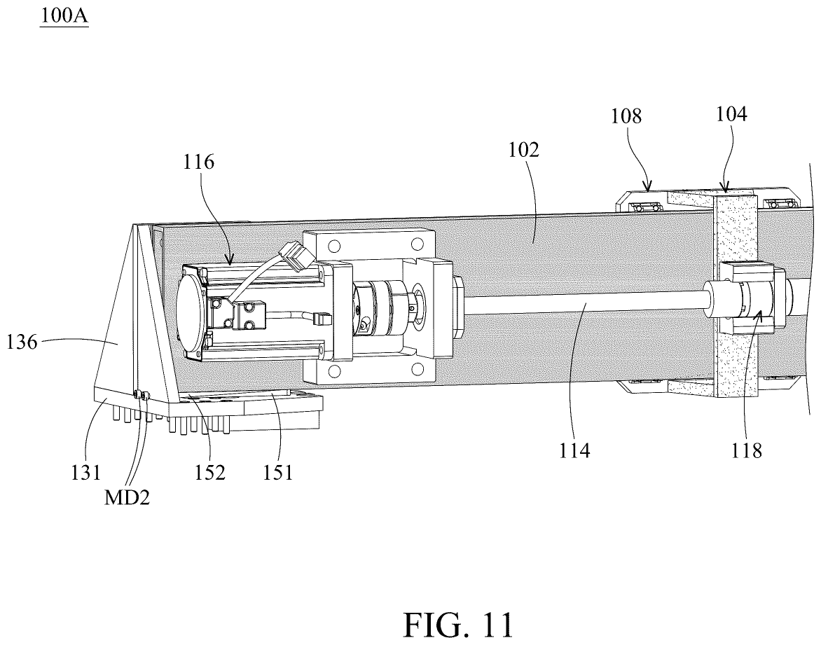

Next, please refer to FIG. 10 to FIG. 11. FIG. 10 is a schematic diagram of a beam mechanism 100A according to another embodiment of the disclosure, and FIG. 11 is a schematic diagram of the beam mechanism 100A in another view according to another embodiment of the disclosure. In this embodiment, the beam mechanism 100A may include a plurality of first fixed elements AD1 (such as screws), and the metal assembly 106 may have a transverse portion 1065 which extends along the first axis AX1. These first fixed elements ADI are configured to fix the slide rails 111, 112 to the transverse portion 1065.

Furthermore, the metal assembly 106 may further have a side portion 1066 which is connected to the transverse portion 1065, and the beam mechanism 100A may further include a plurality of second fixed elements AD2 (such as screws) configured to fix the first supporting base 130 to the side portion 1066 and the beam member 102, so that the first supporting base 130 supports the beam member 102.

Similarly, the metal assembly 106 may further have another side portion 1067 which is connected to the transverse portion 1065, and the second fixed elements AD2 are configured to fix the second supporting base 140 to the side portion 1067 and the beam member 102, so that the second supporting base 140 supports the beam member 102.

In this embodiment, the transverse portion 1065 and the side portions 1066 and 1067 are made of metal material and can be integrally formed as one piece, and the transverse portion 1065 can be formed with a plurality of openwork structures 106H. When viewed along the third axis AX3, the slide rails 111 and 112 do not overlap these openwork structures 106H. Based on such a structural configuration, the metal assembly 106 can be lightweight and have sufficient structural strength.

Similar to the previous embodiment, in this embodiment, the first supporting base 130 has a base portion 131, a supporting portion 132 and two rib portions 136, and the supporting portion 132 extends along the second axis AX2 and is connected to the base portion 131 through the rib portions 136. Similar to the previous embodiment, the beam mechanism 100A may also include two first adjustment elements MD1 configured to pass through the supporting portion 132 and contact the side portion 1066 to adjust the included angle between the supporting portion 132 and the side portion 1066.

Furthermore, as shown in FIG. 11, the beam mechanism 100A may also include a first lifting element 151, a second lifting element 152 and two second adjustment elements MD2. The first lifting element 151 and the second lifting element 152 are disposed between the beam member 102 and the base portion 131.

The second adjustment elements MD2 are configured to pass through the rib portion 136 to contact the second lifting element 152, so that the second lifting element 152 moves relative to the first lifting element 151 to adjust the included angle between the beam member 102 and the base portion 131. The specific adjustment method is the same as the previous embodiment, so it is not described again herein.

In summary, the present disclosure provides a beam mechanism, including a beam member 102, a U-shaped member 104, a sliding member 108, a first supporting base 130 and a second supporting base 140. The first supporting base 130 and the second supporting base 140 are configured to support the beam member 102 and are fixedly disposed on a mechanical platform 50. The sliding member 108 is slidably connected to the sliding rails 111 and 112 on the beam member 102, and the sliding member 108 is connected to a nut 118 via the U-shaped member 104.

The beam mechanism 100 may further include a driving motor 116 and a lead screw 114. The lead screw 114 is connected to the nut 118, and the driving motor 116 is configured to drive the lead screw 114 to rotate to drive the nut 118, the U-shaped member 104 and the sliding member 108 to move. It is worth noting that the sliding member 108 and the driving motor 116 are respectively arranged on the opposite sides of the beam member 102. Therefore, it can avoid the problem in the conventional design that the motor and the sliding member are arranged on the same side, causing the center of gravity to shift to the same side, thereby affecting the movement accuracy.

In addition, in the present disclosure, the beam member 102 is made of carbon fiber material, the beam member 102 may have a hollow tubular structure, and the beam member 102 is connected to the first supporting base 130 and the second supporting base 140 through a metal assembly 106. Based on such a structural configuration, the beam mechanism 100 can have sufficient overall structural strength and can significantly reduce the weight of the beam member 102 so as to achieve overall lightweighting.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A beam mechanism, comprising:
a beam member, made of a carbon fiber material and having a first side wall and a second side wall;
a U-shaped member, disposed on a periphery of the beam member, wherein the U-shaped member extends to the second side wall of the beam member;
a sliding member, located on the first side wall of the beam member and connected to the U-shaped member; and
a moving module, having a slide rail and a lead screw, wherein the slide rail is disposed on the first side wall of the beam member, and the lead screw is disposed on the second side wall of the beam member and connected to the U-shaped member.

2. The beam mechanism as claimed in claim 1, wherein the moving module further includes a driving motor and a nut, the driving motor is affixed to the second side wall of the beam member and is located on a first end of the beam member, and the nut is sleeved on the lead screw and is connected to the U-shaped member.

3. The beam mechanism as claimed in claim 1, wherein the moving module further includes a fixed portion which is fixedly disposed on the second side wall of the beam member and is located on a second end of the beam member, and the beam mechanism further includes a counterweight which is detachably connected to the fixed portion.

4. The beam mechanism as claimed in claim 1, wherein the sliding member is configured to be connected to an external object, the beam mechanism further includes a counterweight which is detachably disposed on the U-shaped member, and a weight of the counterweight corresponds to a weight of the external object.

5. The beam mechanism as claimed in claim 1, wherein the beam mechanism further includes a metal assembly which is affixed to the first side wall of the beam member, and the metal assembly is located between the sliding member and the beam member.

6. The beam mechanism as claimed in claim 5, wherein the beam mechanism further includes a plurality of first locking elements, and the metal assembly has a transverse member which extends along a first axis, wherein the first locking elements are configured to lock the slide rail to the transverse member.

7. The beam mechanism as claimed in claim 6, wherein the beam mechanism further includes a plurality of second locking elements configured to lock the transverse member to the beam member.

8. The beam mechanism as claimed in claim 7, wherein the metal assembly further includes a side member, the beam mechanism further includes a supporting base and a plurality of third locking elements, and the third locking elements are configured to lock the supporting base to the side member, so that the supporting base supports the beam member.

9. The beam mechanism as claimed in claim 8, wherein the beam mechanism further includes a plurality of fourth locking elements configured to lock the supporting base to the side member and the beam member so that the supporting base supports the beam member.

10. The beam mechanism as claimed in claim 9, wherein the supporting base has a base portion, a supporting portion and a first rib portion, the supporting portion extends along a second axis and is connected to the base portion through the first rib portion, and the beam mechanism further includes a first adjustment element configured to pass through the supporting portion and contact the side member, thereby adjusting an included angle between the supporting portion and the side member.

11. The beam mechanism as claimed in claim 10, wherein the beam mechanism further includes a first lifting element, a second lifting element and a second adjustment element, and the first lifting element and the second lifting element are disposed between the beam member and the base portion.

12. The beam mechanism as claimed in claim 11, wherein the second adjustment element is configured to pass through the first rib portion to contact the second lifting element, so that the second lifting element moves relative to the first lifting element to adjust an included angle between the beam member and the base portion.

13. The beam mechanism as claimed in claim 10, wherein the supporting base further has a second rib portion which is connected between the base portion and the supporting portion, and when viewed along the second axis, the first rib portion and the second rib portion are staggered from each other, wherein the second axis is perpendicular to the first axis.

14. The beam mechanism as claimed in claim 10, wherein when viewed along a third axis, the first adjustment element is disposed between the third locking elements and the fourth locking elements, and the third axis, the first axis and the second axis are perpendicular to each other.

15. The beam mechanism as claimed in claim 5, wherein the beam mechanism further includes a plurality of first fixed elements, and the metal assembly has a transverse portion which extends along a first axis, wherein the first fixed elements are configured to fix the slide rail to the transverse portion.

16. The beam mechanism as claimed in claim 15, wherein the metal assembly further has a side portion which is connected to the transverse portion, and the beam mechanism further includes a supporting base and a plurality of second fixed elements, wherein the second fixed elements are configured to fix the supporting base to the side portion and the beam member, so that the supporting base supports the beam member.

17. The beam mechanism as claimed in claim 16, wherein the supporting base has a base portion, a supporting portion and a rib portion, and the supporting portion extends along a second axis and is connected to the base portion through the rib portion.

18. The beam mechanism as claimed in claim 17, wherein the beam mechanism further includes a first adjustment element configured to pass through the supporting portion and contact the side portion to adjust an included angle between the supporting portion and the side portion.

19. The beam mechanism as claimed in claim 18, wherein the transverse portion and the side portion are integrally formed as one piece, and the transverse portion is formed with a plurality of openwork structures.

20. The beam mechanism as claimed in claim 19, wherein when viewed along a third axis, the slide rail does not overlap the openwork structures, and the third axis is perpendicular to the first axis and the second axis.
